(19) United States
(12) Patent Application Publication
(10) Pub. No.: US 2026/0329285 A1
(43) Pub. Date: Oct. 22, 2026

(54) SYSTEMS, DEVICES, AND METHODS FOR PERFORMING LOCAL MAP-BASED PLANE SEGMENTATION

(71) Applicants: Hyundai Motor Company, Seoul (KR); Kia Corporation, Seoul (KR)

(72) Inventors: Yeongmin Song, Hwaseong-Si (KR); Kyungzun Rim, Hwaseong (KR)

(21) Appl. No.: 19/395,584

(22) Filed: Nov. 20, 2025

(30) Foreign Application Priority Data
Apr. 21, 2025 (KR) 10-2025-0051322

(51) Int. Cl. G05D 1/246; G05D 111/10; G05D 111/50; G06T 7/11; G06T 7/60; G06T 7/70; G06T 17/05; G06V 10/25; G06V 10/74; G06V 10/762

(52) U.S. Cl. CPC G05D 1/2469; G06T 7/11; G06T 7/60; G06T 7/70; G06T 17/05; G06V 10/25; G06V 10/761; G06V 10/762; G05D 2111/10; G05D 2111/52; G06T 2207/10024; G06T 2207/10028; G06T 2210/56

(57) ABSTRACT

A local map-based plane segmentation method, performed by a computing device including a processor and a memory, may include calculating a first normal vector of each of a plurality of cells in an integrated point cloud-based local height map integrated in one coordinate system, by the processor, detecting cells of interest of which the first normal vector is similar to a unit vector from among the plurality of cells, and defining a plurality of sub-regions with respect to the cells of interest, by the processor, and dividing a plane region based on a distance between the adjacent cells of interest and a normal vector similarity, in each of the plurality of sub-regions, by the processor.

### CROSS-REFERENCE TO RELATED APPLICATION

This application claims, under 35 U.S.C. § 119(a), the benefit of Korean Patent Application No. 10-2025-0051322, filed Apr. 21, 2025, in the Korean Intellectual Property Office, the entire contents of which are incorporated herein by reference.

### BACKGROUND

### (a) Technical Field

The present disclosure relates to systems, devices, and methods for performing local map-based plane segmentation and, more particularly, to local map-based plane segmentation systems, devices, and methods for dividing a steppable plane for driving robots of various platforms.

### (b) Description of the Related Art

A driving/walking robot is a robot that performs tasks while moving on the ground. Depending on the method of movement, driving/walking robots are broadly divided into two types; a driving robot; and a walking robot.

A driving robot is a robot that moves on the ground using wheels. A walking robot is a robot that walks using legs.

Conventional plane segmentation technology has difficulty in responding to various robot platforms other than wheeled robots. For example, using conventional technologies, it is difficult to secure real-time performance in edge devices by directly processing raw sensor data or using deep learning technology.

In addition, conventional technologies have the problem that they only process currently observed data without temporal accumulation of data, and only instant path planning for immediate avoidance purposes is possible.

### SUMMARY

The present disclosure attempts to provide a local map-based plane segmentation system, device, and method applicable to various robot platforms (driving/walking robot) and capable of determining a steppable region based on plane segmentation.

The present disclosure attempts to provide a local map-based plane segmentation system, device, and method configured to compress sensor data into a local height map and to operate in real time in an edge device through geometric information-based plane segmentation.

The present disclosure attempts to provide a local map-based plane segmentation system, device, and method configured to define a plurality of sub-regions in a local map and to divide a plurality of plane regions through sub-region reference clustering.

A local map-based plane segmentation device, for detecting a plane region for robot driving on a local height map by executing program code loaded on one or more memory devices through one or more processors, where the program code may include, when executed, calculating a first normal vector of each of a plurality of cells in an integrated point cloud-based local height map integrated in one coordinate system, detecting cells of interest of which the first normal vector is similar to a unit vector from among the plurality of cells, and defining a plurality of sub-regions with respect to the cells of interest, and dividing the plane region based on a distance between the adjacent cells of interest and a normal vector similarity, in each of the plurality of sub-regions.

The device may further include calculating a steppability with respect to the plane region, and determining the plane region as a steppable region when the calculated steppability is greater than or equal to a preset reference steppability.

The calculating the first normal vector of each of the plurality of cells in the integrated point cloud-based local height map integrated in one coordinate system may include calculating the first normal vector through averaging of cross products of direction vectors between a plurality of adjacent neighbor cells.

The detecting the cells of interest of which the first normal vector is similar to the unit vector from among the plurality of cells, and defining the plurality of sub-regions with respect to the cells of interest may include calculating a first cosine similarity between the unit vector including a z-axis unit vector and the first normal vector of each of the plurality of cells, and detecting the cells of interest based on the calculated first cosine similarity.

The detecting the cells of interest of which the first normal vector is similar to the unit vector from among the plurality of cells, and defining the plurality of sub-regions with respect to the cells of interest may further include detecting a cell of which the first cosine similarity is greater than or equal to a predetermined reference similarity as the cell of interest.

The detecting the cells of interest of which the first normal vector is similar to the unit vector from among the plurality of cells, and defining the plurality of sub-regions with respect to the cells of interest may include defining the plurality of sub-regions each including preset N cells of interest.

The dividing the plane region based on the distance between the adjacent cells of interest and the normal vector similarity, in each of the plurality of sub-regions may include clustering the points of the cells of interest, to generate a plurality of point clusters based on a distance between cell points of the cells of interest and a similarity of a second normal vector between the cells of interest.

The calculating the steppability with respect to the plane region, and determining the plane region as the steppable region when the calculated steppability is greater than or equal to a preset reference steppability may include representing each of the plurality of point clusters as a polygon including vertices, a central point, and a third normal vector.

The calculating the steppability with respect to the plane region, and determining the plane region as the steppable region when the calculated steppability is greater than or equal to a preset reference steppability may further include calculating the steppability based on a second cosine similarity between a z-axis unit vector and the third normal vector of the polygon.

A local map-based plane segmentation method, performed by a computing device including a processor and a memory, may include calculating a first normal vector of each of a plurality of cells in an integrated point cloud-based local height map integrated in one coordinate system, by the processor, detecting cells of interest of which the first normal vector is similar to a unit vector from among the plurality of cells, and defining a plurality of sub-regions with respect to the cells of interest, by the processor, and dividing a plane region based on a distance between the adjacent cells of interest and a normal vector similarity, in each of the plurality of sub-regions, by the processor.

The method may further include calculating a steppability with respect to the plane region, and determining the plane region as a steppable region when the calculated steppability is greater than or equal to a preset reference steppability, by the processor.

The calculating the first normal vector of each of the plurality of cells in the integrated point cloud-based local height map integrated in one coordinate system may include calculating the first normal vector through averaging of cross products of direction vectors between a plurality of adjacent neighbor cells, by the processor.

The detecting the cells of interest of which the first normal vector is similar to the unit vector from among the plurality of cells, and defining the plurality of sub-regions with respect to the cells of interest may include calculating a first cosine similarity between the unit vector including a z-axis unit vector and the first normal vector of each of the plurality of cells, and detecting the cells of interest based on the calculated first cosine similarity, by the processor.

The detecting the cells of interest of which the first normal vector is similar to the unit vector from among the plurality of cells, and defining the plurality of sub-regions with respect to the cells of interest may further include detecting a cell of which the first cosine similarity is greater than or equal to a predetermined reference similarity as the cell of interest, by the processor.

The detecting the cells of interest of which the first normal vector is similar to the unit vector from among the plurality of cells, and defining the plurality of sub-regions with respect to the cells of interest may include defining the plurality of sub-regions each including preset N cells of interest, by the processor.

The dividing the plane region based on the distance between the adjacent cells of interest and the normal vector similarity, in each of the plurality of sub-regions may include clustering the points of the cells of interest, to generate a plurality of point clusters based on a distance between cell points of the cells of interest and a similarity of a second normal vector between the cells of interest, by the processor.

The calculating the steppability with respect to the plane region, and determining the plane region as the steppable region when the calculated steppability is greater than or equal to a preset reference steppability may include representing each of the plurality of point clusters as a polygon including vertices, a central point, and a third normal vector, by the processor.

The calculating the steppability with respect to the plane region, and determining the plane region as the steppable region when the calculated steppability is greater than or equal to a preset reference steppability may further include calculating the steppability based on a second cosine similarity between a z-axis unit vector and the third normal vector of the polygon, by the processor.

A local map-based plane segmentation system may include a sensor unit including a plurality of cameras and an IM sensor, a data processor configured to compress data received from the sensor unit in the form of a local map, define a plurality of sub-regions with respect to the compressed local map, and detect a plane region based on the plurality of defined sub-regions, and a robot unit configured to generate path planning based on a steppable region including the plane region.

The data processor may include a pose estimation module configured to estimate a pose of the robot with an input of RGBD data and IMU data, an integrated point cloud generating module configured to generate an integrated point cloud integrated in one coordinate system by using the pose of the robot and camera parameter, a local map generating module configured to compress the integrated point cloud, to generate a local height map, and a plane segmentation module configured to define the plurality of sub-regions in the local height map, extract the steppable region in the plane region detected from the plurality of sub-regions, and transfer the extracted steppable region to the robot.

According to a local map-based plane segmentation system, device, and method according to an embodiment, the robot and the plane are aligned through robot-plane relative position with respect to each sub-region and specific numbers are assigned to the sub-regions, so that an intuitive interface is provided to the robot.

A local map-based plane segmentation system, device, and method according to an embodiment may be applied to various robot platform (driving/walking robot) through intuitive interface according to sub-regions.

According to a local map-based plane segmentation system, device, and method according to an embodiment, since information is compressed through a local height map and only geometric information is used, real time performance may be secured in the edge devices.

According to an aspect of the present disclosure, a local map-based plane segmentation device is provided. The local map-based plane segmentation device may comprise a computing device, comprising a processor and memory. The memory may be configured to store instructions that, when executed by the processor, are configured to cause the processor to calculate a first normal vector of each of a plurality of cells in an integrated point cloud-based local height map integrated in one coordinate system, detect cells of interest, wherein the first normal vector is similar to a unit vector from among the plurality of cells, define a plurality of sub-regions with respect to the cells of interest, and divide a plane region for robot driving on the local height map based on a distance between adjacent cells of interest and a normal vector similarity, in each of the plurality of sub-regions.

According to an exemplary embodiment, the computing device may be further configured to calculate a steppability with respect to the plane region and determine the plane region as a steppable region when the calculated steppability is greater than or equal to a preset reference steppability.

According to an exemplary embodiment, the calculating the first normal vector of each of the plurality of cells in the integrated point cloud-based local height map integrated in one coordinate system may comprise calculating the first normal vector through averaging of cross products of direction vectors between a plurality of adjacent neighbor cells.

According to an exemplary embodiment, the detecting the cells of interest and the defining the plurality of sub-regions with respect to the cells of interest may comprise calculating a first cosine similarity between the unit vector comprising a z-axis unit vector and the first normal vector of each of the plurality of cells and detecting the cells of interest based on the calculated first cosine similarity.

According to an exemplary embodiment, the detecting the cells of interest and the defining the plurality of sub-regions with respect to the cells of interest further may comprise detecting a cell of which the first cosine similarity is greater than or equal to a predetermined reference similarity as the cell of interest.

According to an exemplary embodiment, the detecting the cells of interest and the defining the plurality of sub-regions with respect to the cells of interest may comprise defining the plurality of sub-regions each comprising preset N cells of interest.

According to an exemplary embodiment, the dividing the plane region based on the distance between the adjacent cells of interest and the normal vector similarity, in each of the plurality of sub-regions may comprise clustering points of the cells of interest to generate a plurality of point clusters based on a distance between cell points of the cells of interest and a similarity of a second normal vector between the cells of interest.

According to an exemplary embodiment, the calculating the steppability with respect to the plane region, and the determining the plane region as the steppable region when the calculated steppability is greater than or equal to a preset reference steppability may comprise representing each of the plurality of point clusters as a polygon comprising vertices, a central point, and a third normal vector.

According to an exemplary embodiment, the calculating the steppability with respect to the plane region, and determining the plane region as the steppable region when the calculated steppability is greater than or equal to the preset reference steppability may comprise calculating the steppability based on a second cosine similarity between a z-axis unit vector and the third normal vector of the polygon.

According to an aspect of the present disclosure, a local map-based plane segmentation method is provided. The method may comprise, using a computing device comprising a processor and a memory, calculating a first normal vector of each of a plurality of cells in an integrated point cloud-based local height map integrated in one coordinate system, detecting cells of interest, wherein the first normal vector is similar to a unit vector from among the plurality of cells, defining a plurality of sub-regions with respect to the cells of interest, and Dividing a plane region based on a distance between adjacent cells of interest and a normal vector similarity, in each of the plurality of sub-regions.

According to an exemplary embodiment, the method may comprise calculating a steppability with respect to the plane region and determining the plane region as a steppable region when the calculated steppability is greater than or equal to a preset reference steppability.

According to an exemplary embodiment, the calculating the first normal vector of each of the plurality of cells in the integrated point cloud-based local height map integrated in one coordinate system may comprise calculating the first normal vector through averaging of cross products of direction vectors between a plurality of adjacent neighbor cells.

According to an exemplary embodiment, the detecting the cells of interest of which the first normal vector and the defining the plurality of sub-regions with respect to the cells of interest may comprise calculating a first cosine similarity between the unit vector comprising a z-axis unit vector and the first normal vector of each of the plurality of cells, and detecting the cells of interest based on the calculated first cosine similarity.

According to an exemplary embodiment, the detecting the cells of interest of which the first normal vector and the defining the plurality of sub-regions with respect to the cells of interest may comprise detecting a cell of which the first cosine similarity is greater than or equal to a predetermined reference similarity as the cell of interest.

According to an exemplary embodiment, the detecting the cells of interest and the defining the plurality of sub-regions with respect to the cells of interest may comprise defining the plurality of sub-regions each comprising preset N cells of interest.

According to an exemplary embodiment, the dividing the plane region based on the distance between the adjacent cells of interest and the normal vector similarity, in each of the plurality of sub-regions may comprise clustering the points of the cells of interest to generate a plurality of point clusters based on a distance between cell points of the cells of interest and a similarity of a second normal vector between the cells of interest.

According to an exemplary embodiment, the calculating the steppability with respect to the plane region, and the determining the plane region as the steppable region when the calculated steppability is greater than or equal to the preset reference steppability may comprise representing each of the plurality of point clusters as a polygon comprising vertices, a central point, and a third normal vector.

According to an exemplary embodiment, the calculating the steppability with respect to the plane region, and the determining the plane region as the steppable region when the calculated steppability is greater than or equal to the preset reference steppability may comprise calculating the steppability based on a second cosine similarity between a z-axis unit vector and the third normal vector of the polygon.

According to an aspect of the present disclosure, a local map-based plane segmentation system is provided. The local map-based plane segmentation system may comprise a sensor unit comprising a plurality of cameras and an IMU sensor, a data processor configured to compress data received from the sensor unit in the form of a local map, define a plurality of sub-regions with respect to the compressed local map, and detect a plane region based on the plurality of defined sub-regions, and a robot unit configured to generate path planning based on a steppable region comprising the plane region.

According to an exemplary embodiment, the data processor may comprise a pose estimation module configured to estimate a pose of the robot with an input of RGBD data and IMU data, an integrated point cloud generating module configured to generate an integrated point cloud integrated in one coordinate system by using the pose of the robot and camera parameter, a local map generating module configured to compress the integrated point cloud, to generate a local height map, and a plane segmentation module configured to define the plurality of sub-regions in the local height map, extract the steppable region in the plane region detected from the plurality of sub-regions, and transfer the extracted steppable region to the robot.

### BRIEF DESCRIPTION OF THE DRAWINGS

The foregoing and other aspects, features, and advantages, as well as the following detailed description of the embodiments, will be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 and FIG. 2 illustrate drawings showing a local map-based plane segmentation system, according to exemplary embodiments of the present disclosure.

FIG. 3 illustrates a drawing showing a local map-based plane segmentation device, according to an exemplary embodiment of the present disclosure.

FIG. 4 illustrates a drawing for explaining a method for calculating a first normal vector, according to an exemplary embodiment of the present disclosure.

FIG. 5 illustrates a drawing for explaining a method for dividing a sub-region, according to an exemplary embodiment of the present disclosure.

FIG. 6 illustrates a drawing for explaining a method for dividing a plane region, according to an exemplary embodiment of the present disclosure.

FIG. 7 illustrates a drawing for explaining a method for determining stoppable regions, according to an exemplary embodiment of the present disclosure.

FIG. 8 and FIG. 9 are flowcharts of a local map-based plane segmentation method, according to exemplary embodiments of the present disclosure.

FIG. 10 illustrates a drawing for explaining the Comparative Example, according to an exemplary embodiment of the present disclosure.

FIG. 11 illustrates a drawing for explaining an effect of an embodiment of the present disclosure.

FIG. 12 illustrates a drawing for explaining a computing device, according to an exemplary embodiment of the present disclosure.

### DETAILED DESCRIPTION

An embodiment of the disclosure will be described more fully hereinafter with reference to the accompanying drawings such that a person skill in the art may easily implement the embodiment. As those skilled in the art would realize, the described embodiments may be modified in various different ways, all without departing from the spirit or scope of the present disclosure. In order to clarify the present disclosure, parts that are not related to the description will be omitted, and the same elements or equivalents are referred to with the same reference numerals throughout the specification.

In addition, unless explicitly described to the contrary, the word “comprise” and variations such as “comprises” or “comprising” will be understood to imply the inclusion of stated elements but not the exclusion of any other elements. Terms including an ordinary number, such as first and second, are used for describing various constituent elements, but the constituent elements are not limited by the terms. The terms are only used to differentiate one component from other components.

In addition, the terms “unit”, “part” or “portion”, “-er”, and “module” in the specification refer to a unit that processes at least one function or operation, which may be implemented by hardware, software, or a combination of hardware and software.

Additionally, at least some of the configurations or functions of a local map-based plane segmentation system, device, and method according to the embodiments described below may be implemented as a program or software, and the program or software may be stored in a computer-readable medium.

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well-known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

Hereinafter, various embodiments disclosed in the present disclosure will be described in detail with reference to the accompanying drawings, and the same or similar elements are designated by the same reference numerals regardless of the numerals in the drawings and redundant description thereof will be omitted.

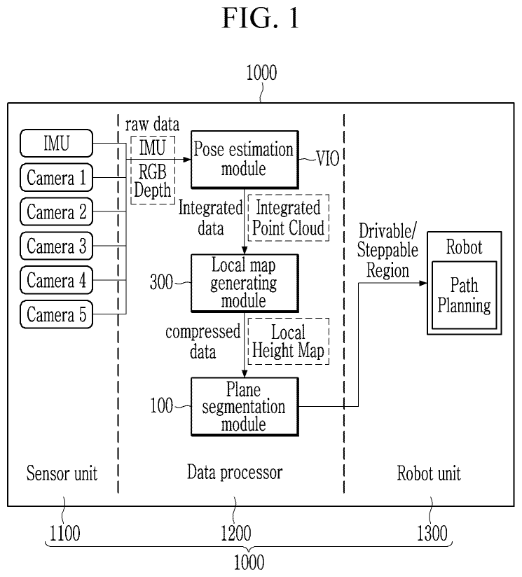

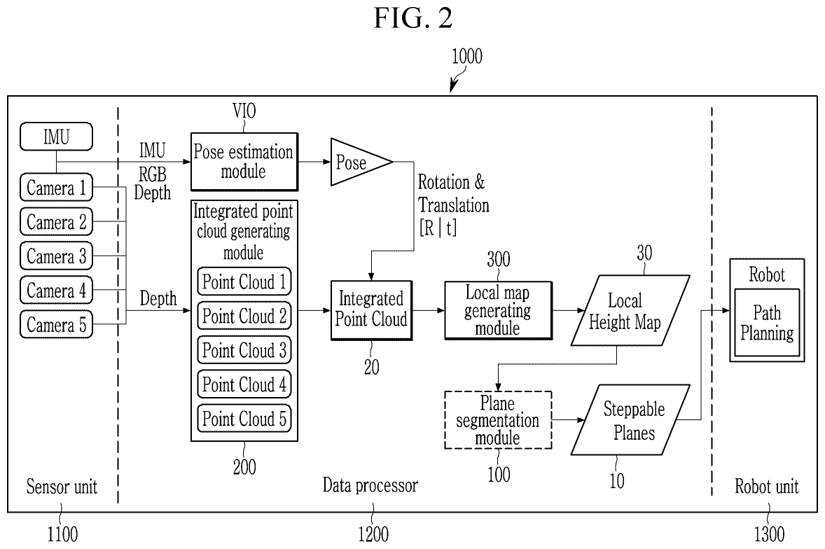

FIG. 1 and FIG. 2 illustrate drawings showing a local map-based plane segmentation system, according to exemplary embodiments of the present disclosure.

FIG. 1 illustrates a schematic diagram of a local map-based plane segmentation system, according to an exemplary embodiment of the present disclosure. FIG. 2 illustrates a block diagram of a local map-based plane segmentation system, according to an exemplary embodiment of the present disclosure.

Referring to FIG. 1 and FIG. 2, a local map-based plane segmentation system 1000 may comprise a sensor unit 1100, data processor 1200, and a robot unit 1300.

The sensor unit 1100 may comprise a plurality of cameras and an IMU sensor. The sensor unit 1100 may be configured to provide RGB-Depth data through, e.g., the plurality of cameras, and may be configured to provide IMU data through, e.g., the IMU sensor.

RGB data may comprise color information (Red, Green, and Blue), and depth (D) data may comprise depth (distance) information obtained by using a stereo infrared (IR) sensor.

An inertial measurement unit (IMU) sensor may comprise a sensor configured to estimate rotation (angular velocity) and motion (linear acceleration) of an object by measuring the moment of inertia. That is, the IMU data may comprise the rotation (angular velocity) and motion (linear acceleration) of the object.

The data processor 1200 may be configured to compress data received from the sensor unit 1100 in the form of a local map.

The data processor 1200 may be configured to define a plurality of sub-regions with respect to the compressed local map.

The data processor 1200 may be configured to detect a plane region based on the plurality of defined sub-regions.

The data processor 1200 may comprise a pose estimation module (VIO), a plane segmentation module 100, an integrated point cloud generating module 200, and a local map generating module 300.

The pose estimation module (VIO) may be configured to estimate a pose of the robot based, e.g., on the IMU data and RGB-D data.

The pose may comprise an accumulated movement distance and a current rotation state of the robot.

The integrated point cloud generating module 200 may be configured to generate an integrated point cloud 20, integrated in one coordinate system by using the pose of the robot and camera parameter. That is, the integrated point cloud generating module 200 may be configured to output the integrated point cloud 20 integrated within one 3-dimensional coordinate system (e.g., world, map, odometry), in response to the input of Depth data for each camera, internal/external parameters of the camera, and a robot pose.

The local map generating module 300 may be configured to compress the integrated point cloud 20 to generate a local height map 30. That is, the local map generating module 300 may be configured to output the local height map (2.5D) 30 in response to the input of an integrated point cloud (3D) 20.

The plane segmentation module 100 may be configured to define the plurality of sub-regions in the local height map 30, and may be configured to extract a steppable plane 10 in the plane region detected from the plurality of sub-regions and transfer it to the robot unit 1300. That is, the plane segmentation module 100 may be configured to output a steppable 3D plane 10 in response to the local height map (2.5D).

Here, the steppable plane 10 may be represented by approximating a polygonal form with vertices, a position of a central point, and a normal vector value.

The robot unit 1300 may be configured to generate a driving/walking path planning of the robot based on the outputted steppable plane 10.

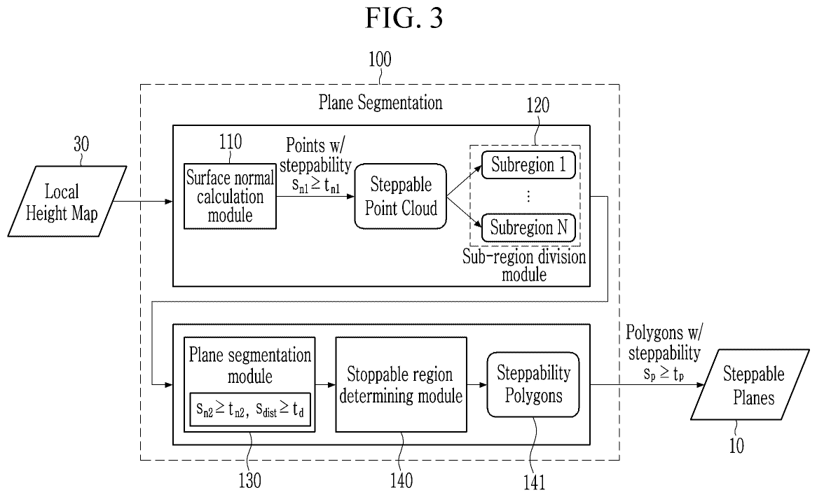

FIG. 3 illustrates a drawing showing a local map-based plane segmentation device, according to an exemplary embodiment of the present disclosure.

A local map-based plane segmentation device 100 may be configured to output the steppable plane 10 through plane segmentation in response to the input of the local height map 30.

In the present disclosure, hereinafter, a steppable region may comprise a steppable plane.

The local map-based plane segmentation device 100, according to an exemplary embodiment, may comprise the plane segmentation module 100 of FIG. 1 and FIG. 2.

According to an exemplary embodiment, one or more memory devices may be configured to store instructions that, when executed by one or more processors, are configured to cause the one or more processors to perform one or more actions/tasks of the present disclosure as described herein. The one or more processors may correspond to the processor 910 of the computing device 900, and one or more memory devices may correspond to a memory 930 of the computing device 900.

In FIG. 3, the local map-based plane segmentation device 100, according to an exemplary embodiment, may be configured to execute program codes loaded on the one or more memory devices or instructions through the one or more processors.

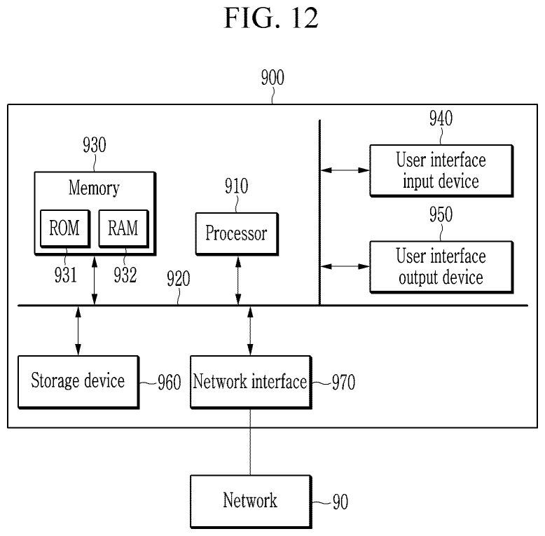

For example, the local map-based plane segmentation device 100 may be implemented as a computing device 900 described later with reference to FIG. 12. In this case, the one or more processors may correspond to the processor 910 of the computing device 900, and one or more memory devices may correspond to a memory 930 of the computing device 900.

By being executed by the one or more processors, the program codes or instructions may be configured to divide and cluster cells of interest detected based on a surface normal vector on the local height map into sub-regions, detect the plane region in cluster units, and may be configured to determine some of them as the steppable region. In this disclosure, the term “module” is used to logically differentiate functions performed by the program code or instruction.

Referring to FIG. 3, the local map-based plane segmentation device 100 may comprise a surface normal calculation module 110, a sub-region division module 120, a plane segmentation module 130, and a steppable region determining module 140.

The surface normal calculation module 110 may be configured to calculate the surface normal vector of each of a plurality of cells in integrated point cloud-based local height map integrated in one coordinate system.

The surface normal calculation module 110 may be configured to calculate the surface normal vector through averaging of cross products of direction vectors between a plurality of adjacent neighbor cells.

The sub-region division module 120 may be configured to detect the cells of interest of which the surface normal vector is similar to a unit vector from among the plurality of cells.

The sub-region division module 120 may be configured to calculate a cosine similarity between a z-axis unit vector and the surface normal vector of each of the plurality of cells.

The sub-region division module 120 may be configured to detect the cells of interest based on the calculated cosine similarity.

The sub-region division module 120 may be configured to detect a cell of which the calculated cosine similarity is greater than or equal to a predetermined reference similarity as the cell of interest.

The sub-region division module 120 may be configured to define the plurality of sub-regions with respect to the cells of interest.

The sub-region division module 120 may be configured to define the plurality of sub-regions each including preset N cells of interest.

The plane segmentation module 130 may be configured to divide the plane region based on a distance between the adjacent cells of interest and a normal vector similarity, in each of the plurality of sub-regions.

The plane segmentation module 130 may be configured to cluster the points of the cells of interest, to generate a plurality of point clusters based on a distance between cell points of the cells of interest and a similarity of the surface normal vector between the cells of interest

The plane segmentation module 130 may be configured to divide sub-regions including the point clusters as the plane region.

The steppable region determining module 140 may be configured to calculate a steppability with respect to the plane region.

The steppable region determining module 140 may be configured to represent each of the plurality of point clusters as a polygon 141 including vertices, a central point, and a normal vector.

The steppable region determining module 140 may be configured to calculate the steppability based on the cosine similarity between the z-axis unit vector and the normal vector of the polygon 141.

When the steppability is greater than or equal to a preset reference steppability, the steppable region determining module 140 may be configured to determine the divided plane region as the steppable region 10.

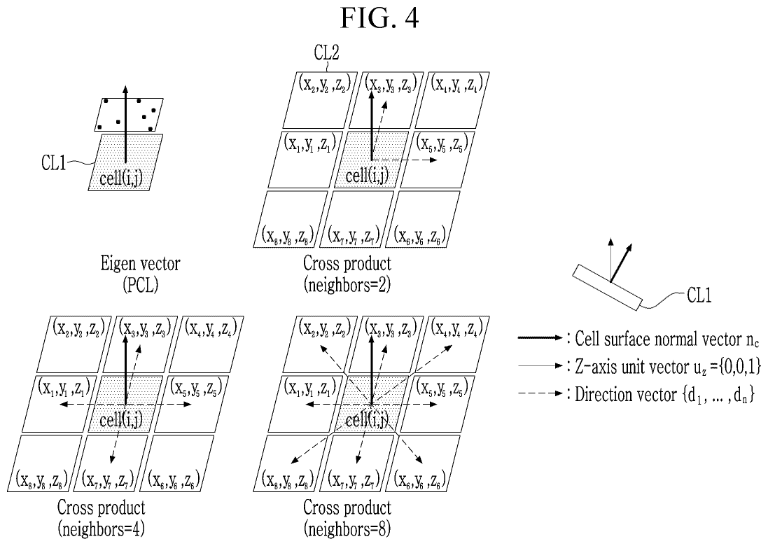

FIG. 4 illustrates a drawing for explaining a method for calculating a first normal vector, according to an exemplary embodiment of the present disclosure.

In FIG. 4, the local map may comprise the plurality of cells. The plurality of cells may comprise a central cell CL1 and neighbor cells CL2. The cell may be a minimum configuration unit of a local map.

In the central cell CL1, a maximum height of a point cloud within a cell based on a 3D point cloud existing within a cell may be determined as the height of the cell.

The local map-based plane segmentation device 100 may be configured to calculate the surface normal vector of the central cell CL1 by using the neighbor cells CL2.

For example, the local map-based plane segmentation device 100 may be configured to calculate the surface normal vector based on two, four, or eight neighbor cells CL2.

The local map-based plane segmentation device 100 may be configured to calculate an average of cross products of direction vectors {d₁, . . . , dₙ} between m neighbor cells CL2 by using Equation 1, to calculate the surface normal vector n_{c}.

$${n}_{c} = \frac{( {d}_{1} \times {d}_{m} )}{m} + \frac{( {d}_{m} \times {d}_{m - 1} ) + … + ( {d}_{2} \times {d}_{1} )}{m} \qquad Equation 1$$

The local map-based plane segmentation device 100 may be configured to calculate a first cosine similarity sₙ₁ between the z-axis unit vector u_{z}={0, 0, 1} and the surface normal vector n_{c}={xₙ, yₙ, zₙ} by using Equation 2.

$${s}_{n 1} = \frac{{u}_{z} \cdot {n}_{c}}{\vert {u}_{z} \vert \vert {n}_{c} \vert} = \frac{( 0 {x}_{n} + 0 {y}_{n} + 1 {z}_{n} )}{1 \sqrt{{x}_{n}^{2} + {y}_{n}^{2} + {z}_{n}^{2}}} \qquad Equation 2$$

The local map-based plane segmentation device 100 may be configured to determine cells of which the first cosine similarity sₙ₁ is greater than or equal to a reference similarity tₙ₁ as the cells of interest and provide them as the input of point clustering.

At this time, the local map-based plane segmentation device 100 may be configured to divide the cells of interest into sub-regions.

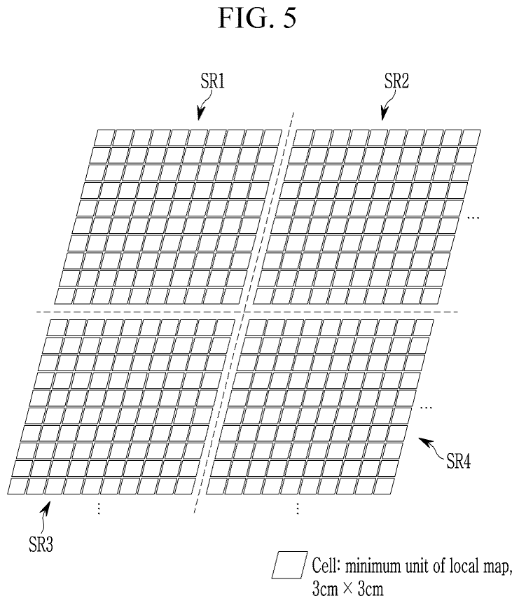

FIG. 5 illustrates a drawing for explaining a method for dividing a sub-region, according to an exemplary embodiment of the present disclosure.

The local map-based plane segmentation device 100 may be configured to define the plurality of sub-regions each including the N cells of interest. N may be set as an arbitrary number.

FIG. 5 shows first to fourth sub-regions SR1, SR2, SR3, and SR4 in the case that the size of each cell of interest is determined as 3 cm×3 cm, and the size of the sub-region is set to 30 cm×30 cm.

The first to fourth sub-regions SR1, SR2, SR3, and SR4 may form the entire region.

Each of the first to fourth sub-regions SR1, SR2, SR3, and SR4 may comprise 100 cells of interest (10×10).

When the sub-regions are not divided, the entire region of the local map may have only one sub-region.

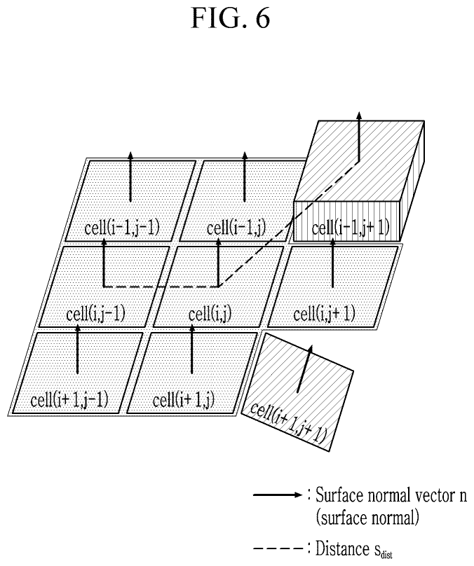

FIG. 6 illustrates a drawing for explaining a method for dividing the plane region, according to an exemplary embodiment of the present disclosure.

FIG. 6 shows one sub-region. In FIG. 6, the sub-region may include 6 cells of interest (3×3).

In FIG. 6, the local map-based plane segmentation device 100 may be configured to perform point clustering with respect to the sub-regions.

The position cₘ of cell m within the sub-region may be {xₘ, yₘ, zₘ}.

The local map-based plane segmentation device 100 may be configured to calculate a distance S_{dist} between neighbor cells c₁ and c₂ within the sub-region through Equation 3.

s_{dist}=∥c₁−c₂∥=\sqrt{(x₁−x₂)²+(y₁−y₂)²+(z₁−z₂)²} Equation 3

The surface normal vector (nₘ) of the cell m within the sub-region may be {xₙₘ, yₙₘ, zₙₘ}.

The local map-based plane segmentation device 100 may be configured to calculate the similarity sₙ₂ of the surface normal vector between neighbor cells within the sub-region through Equation 4.

$${s}_{n 2} = \frac{{n}_{1} \cdot {n}_{2}}{\vert {n}_{1} \vert \vert {n}_{2} \vert} = \frac{( {x}_{n 1} {x}_{n 2} + {y}_{n 1} {y}_{n 2} + {z}_{n 1} {z}_{n 2} )}{\sqrt{{x}_{n 1}^{2} + {y}_{n {1}^{2}} + {z}_{n {1}^{2}}} \sqrt{{{x}_{n 1}}_{{2}^{}} + {y}_{n 2}^{2} + {z}_{n 2}^{2}}} \qquad Equation 4$$

The local map-based plane segmentation device 100 may be configured to generate one point cluster to include cells of which the distance between neighbor cells does not exceed a reference distance, and the similarity of the surface normal vector between neighbor cells does not exceed a reference similarity among the cells of interest within the sub-region.

The local map-based plane segmentation device 100 may be configured to divide sub-regions including the point clusters as the plane region.

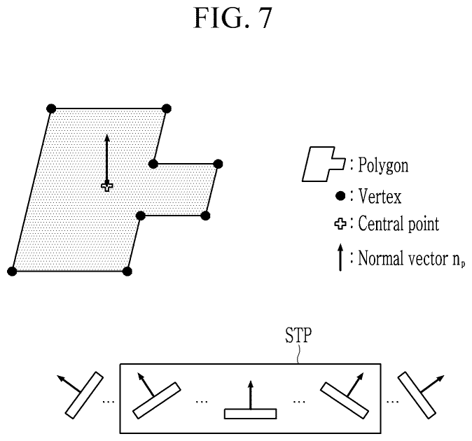

FIG. 7 illustrates a drawing for explaining a method for determining steppable regions, according to an exemplary embodiment of the present disclosure.

In FIG. 7, the local map-based plane segmentation device 100 may be configured to represent the point clusters as geometric information of polygons, respectively.

The polygon may be composed of vertices, a central point, and the normal vector.

The vertices may be representative points of an outer boundary line of the polygon, and the central point and the normal vector nₚ={xₚₙ, yₚₙ, zₚₙ} may be calculated as an average of point information (position and normal) pieces within the point cluster.

The local map-based plane segmentation device 100 may be configured to calculate the steppability sₚ as the cosine similarity between the normal vector nₚ and the z-axis unit vector u_{z}={0, 0, 1} through Equation 5.

$${s}_{p} = \frac{{u}_{z} \cdot {n}_{p}}{\vert {u}_{z} \vert \vert {n}_{p} \vert} = \frac{( 0 {x}_{pn} + 0 {y}_{pn} + 1 {z}_{pn} )}{1 \sqrt{{x}_{pn}^{2} + {y}_{pn}^{2} + {z}_{pn}^{2}}} \qquad Equation 5$$

The local map-based plane segmentation device 100 may be configured to determine the plane regions of which the steppability sₚ of the normal vector of the polygon is greater than or equal to a reference steppability tₚ as the steppable regions.

The local map-based plane segmentation device 100 may be configured to calculate the reference steppability tₚ through Equation 6.

tₚ=1−cos θₚ Equation 6

For example, when the steppable inclination θₚ of the steppable plane reference is set to be within 30 degrees, the reference steppability tₚ may be about 0.85.

The local map-based plane segmentation device 100 may be configured to finally determine a steppable plane STP from among a plurality of clusters by comparing a predetermined reference steppability and the steppability based on a steppable reference inclination.

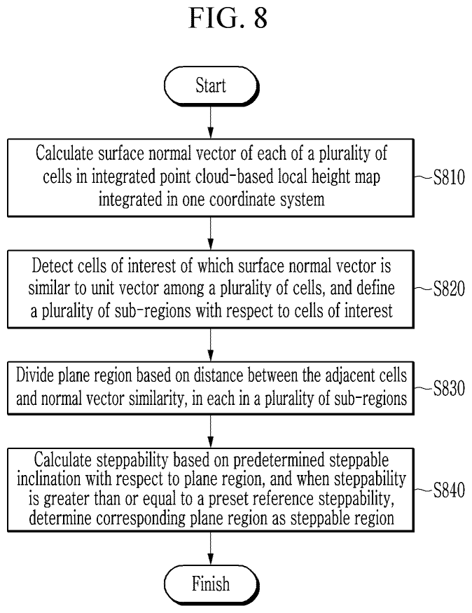

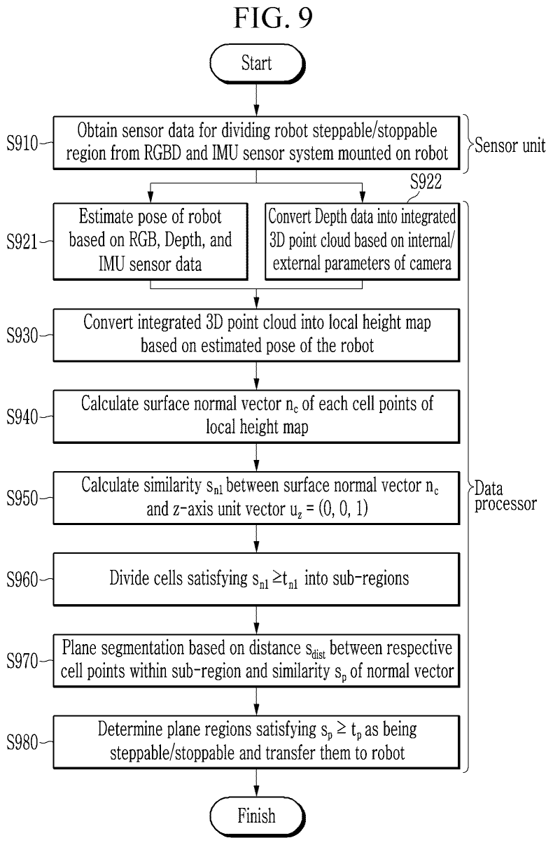

FIG. 8 and FIG. 9 illustrate flowcharts of a local map-based plane segmentation method, according to exemplary embodiments of the present disclosure. The local map-based plane segmentation methods of FIG. 8 and FIG. 9 may be performed through the local map-based plane segmentation device 100 of FIG. 3.

FIG. 8 illustrates a flowchart of the local map-based plane segmentation method, according to an exemplary embodiment of the present disclosure.

In FIG. 8, the local map-based plane segmentation device 100 may be configured to calculate the surface normal vector of each of the plurality of cells in integrated point cloud-based local height map integrated in one coordinate system, at step S810.

The local map-based plane segmentation device 100 may be configured to detect the cells of interest of which the surface normal vector is similar to a unit vector from among the plurality of cells, and may define the plurality of sub-regions with respect to the cells of interest, at step S820.

The local map-based plane segmentation device 100 may be configured to divide the plane region based on the distance between the adjacent cells and the normal vector similarity, in each of the plurality of sub-regions, at step S830.

The local map-based plane segmentation device 100 may be configured to calculate the steppability based on a predetermined steppable inclination with respect to the plane region, and when the steppability is greater than or equal to the preset reference steppability, may be configured to determine a corresponding plane region as the steppable region, at step S840.

FIG. 9 illustrates a flowchart for explaining a detailed embodiment of the local map-based plane segmentation method. The embodiments described with reference to the flowchart of FIG. 9 may comprise the embodiments described above with reference to FIG. 4 to FIG. 7.

In FIG. 9, the local map-based plane segmentation device 100 may be configured to obtain sensor data for dividing the robot steppable region from the RGBD and IMU sensor system mounted on the robot, at step S910.

The local map-based plane segmentation device 100 may be configured to estimate the pose of the robot based on the RGB, Depth, and IMU sensor data, at step S921.

The local map-based plane segmentation device 100 may be configured to convert Depth data into the integrated 3D point cloud based on internal/external parameters of the camera, at step S922.

The local map-based plane segmentation device 100 may be configured to convert the integrated 3D point cloud into the local height map based on the estimated pose of the robot, at step S930.

The local map-based plane segmentation device 100 may be configured to calculate the surface normal vector of respective cell points of the local height map, at step S940.

The local map-based plane segmentation device 100 may be configured to calculate the surface normal vector through averaging of cross products of direction vectors between the plurality of adjacent neighbor cells.

The local map-based plane segmentation device 100 may be configured to calculate the similarity sₙ₁ between the surface normal vector and the z-axis unit vector, at step S950.

The local map-based plane segmentation device 100 may be configured to calculate the cosine similarity between the z-axis unit vector and the surface normal vector of each of the plurality of cells, and may be configured to detect the cells of interest based on the calculated cosine similarity.

The local map-based plane segmentation device 100 may be configured to determine cells with the similarity sₙ₁≥tₙ₁ that is greater than or equal to a predetermined reference similarity tₙ₁ as the cells of interest, and may be configured to divide the region where the cells of interest are disposed into a plurality of sub-regions, at step S960.

The local map-based plane segmentation device 100 may be configured to perform the plane segmentation based on the distance s_{dist} between respective cell points within the sub-region and the similarity sₚ of the normal vector, at step S970.

The local map-based plane segmentation device 100 may be configured to cluster (point clustering) the points of the cells of interest of which the distance between cell points of the cells of interest and a similarity of the normal vector between the cells of interest satisfy a preset criterion, to generate point clusters.

The local map-based plane segmentation device 100 may be configured to divide the plane regions each including the point clusters among the sub-regions.

The local map-based plane segmentation device 100 may be configured to represent each of the plurality of point clusters as a polygon including vertices, a central point, and a third normal vector.

The local map-based plane segmentation device 100 may be configured to determine the plane region satisfying sₚ≥tₚ (i.e., having the similarity of the normal vector that is greater than or equal to a reference similarity tₚ) among the plane regions as being steppable, and transfer it to the robot, at step S980.

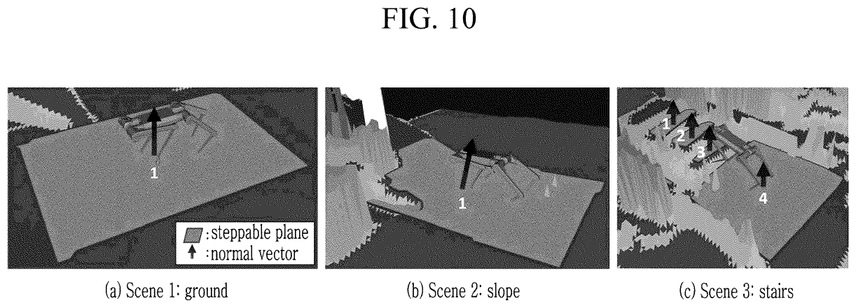

FIG. 10 illustrates a drawing for explaining the Comparative Example. The Comparative Example shows three scenarios of a quadruped robot. The three scenarios may comprise embodiments for the ground, slope, and stairs.

In FIG. 10, the Comparative Example does not divide a region including the cells of interest in to sub-regions. That is, the Comparative Example shows the plane segmentation when the sub-regions are not divided.

In the case of the Comparative Example, it may be seen that the intuitiveness of the plane in the slope scenario is low, since the path planning is required for each leg of the robot.

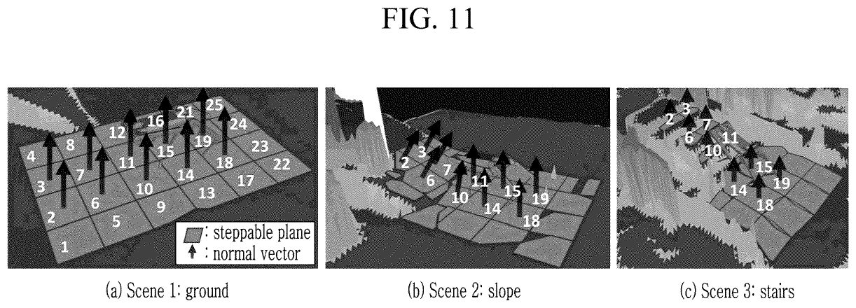

FIG. 11 illustrates a drawing for explaining an effect of an embodiment.

The embodiment of FIG. 11 shows three scenarios of a quadruped robot. The three scenarios may comprise embodiments for the ground, slope, and stairs.

In (b) and (c) of FIG. 11, the normal vectors and the numbers are shown with respect to only the adjacent plane of the robot leg.

In FIG. 11, the embodiment may divide a region including the cells of interest in to sub-regions.

For example, the embodiment shows a case where a driving/walking region-of-interest of the robot is 90 cm to the front, 90 cm to the rear, 60 cm to the left, and 60 cm to the right from the robot center. At this time, region-of-interest may include 24 sub-regions ((3+3)×(2+2)).

In an embodiment, unlike the Comparative Example, when the sub-regions are divided, an intuitive response to the path planning of the quadruped robot is possible in three scenarios.

That is, in an embodiment, the region-of-interest is divided into sub-regions, and each sub-region is assigned with a specific number through alignment through a robot-plane relative position, so that an intuitive interface may be provided to the robot.

FIG. 12 is a diagram for describing a computing device according to an embodiment of the present disclosure.

Referring to FIG. 12, a local map-based plane segmentation system, device, and method, according to exemplary embodiments, may be implemented by using the computing device 900.

The computing device 900 may comprise at least one of a processor 910, a memory 930, the user interface input device 940, the user interface output device 950 and a storage device 960 that communicate through a bus 920. The computing device 900 may also comprise a network interface 970 electrically connected to a network 90. The network interface 970 may be configured to transmit or receive signals with other entities through the network 90.

The processor 910 may be implemented in various types such as a micro controller unit (MCU), an application processor (AP), a central processing unit (CPU), a graphic processing unit (GPU), a neural processing unit (NPU), and the like, and may be any type of semiconductor device capable of executing instructions stored in the memory 930 or the storage device 960. The processor 910 may be configured to implement the functions and methods described above with respect to FIG. 1 to FIG. 11.

The memory 930 and the storage device 960 may comprise various types of volatile or non-volatile storage media. For example, the memory may comprise a read-only memory (ROM) 931 and random-access memory (RAM) 932. In this embodiment, the memory 930 may be located inside or outside processor 910, and the memory 930 may be connected to the processor 910 through various known means.

In some embodiments, at least some configurations or functions of a local map-based plane segmentation system, device, and method according to an embodiment may be implemented as a program or software executable by the computing device 900, and program or software may be stored in a computer-readable medium.

In some embodiments, at least some configurations or functions of a local map-based plane segmentation system, device, and method according to an embodiment may be implemented by using hardware or circuitry of the computing device 900, or may also be implemented as separate hardware or circuitry that may be electrically connected to the computing device 900.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A local map-based plane segmentation device, comprising:
a computing device, comprising a processor and memory, wherein the memory is configured to store instructions that, when executed by the processor, are configured to cause the processor to:
calculate a first normal vector of each of a plurality of cells in an integrated point cloud-based local height map integrated in one coordinate system;
detect cells of interest, wherein the first normal vector is similar to a unit vector from among the plurality of cells;
define a plurality of sub-regions with respect to the cells of interest; and
divide a plane region for robot driving on the local height map based on a distance between adjacent cells of interest and a normal vector similarity, in each of the plurality of sub-regions.

2. The local map-based plane segmentation device of claim 1, wherein the computing device is further configured to:
calculate a steppability with respect to the plane region; and
determine the plane region as a steppable region when the calculated steppability is greater than or equal to a preset reference steppability.

3. The local map-based plane segmentation device of claim 1, wherein the calculating the first normal vector of each of the plurality of cells in the integrated point cloud-based local height map integrated in one coordinate system comprises:
calculating the first normal vector through averaging of cross products of direction vectors between a plurality of adjacent neighbor cells.

4. The local map-based plane segmentation device of claim 1, wherein the detecting the cells of interest and the defining the plurality of sub-regions with respect to the cells of interest comprises:
calculating a first cosine similarity between the unit vector comprising a z-axis unit vector and the first normal vector of each of the plurality of cells; and
detecting the cells of interest based on the calculated first cosine similarity.

5. The local map-based plane segmentation device of claim 4, wherein the detecting the cells of interest and the defining the plurality of sub-regions with respect to the cells of interest further comprises:
detecting a cell of which the first cosine similarity is greater than or equal to a predetermined reference similarity as the cell of interest.

6. The local map-based plane segmentation device of claim 1, wherein the detecting the cells of interest and the defining the plurality of sub-regions with respect to the cells of interest comprises:
defining the plurality of sub-regions each comprising preset N cells of interest.

7. The local map-based plane segmentation device of claim 2, wherein the dividing the plane region based on the distance between the adjacent cells of interest and the normal vector similarity, in each of the plurality of sub-regions comprises:
clustering points of the cells of interest to generate a plurality of point clusters based on a distance between cell points of the cells of interest and a similarity of a second normal vector between the cells of interest.

8. The local map-based plane segmentation device of claim 7, wherein the calculating the steppability with respect to the plane region, and the determining the plane region as the steppable region when the calculated steppability is greater than or equal to a preset reference steppability comprises:
representing each of the plurality of point clusters as a polygon comprising vertices, a central point, and a third normal vector.

9. The local map-based plane segmentation device of claim 8, wherein the calculating the steppability with respect to the plane region, and determining the plane region as the steppable region when the calculated steppability is greater than or equal to the preset reference steppability further comprises:
calculating the steppability based on a second cosine similarity between a z-axis unit vector and the third normal vector of the polygon.

10. A local map-based plane segmentation method, the method comprising:
using a computing device comprising a processor and a memory:
calculating a first normal vector of each of a plurality of cells in an integrated point cloud-based local height map integrated in one coordinate system;
detecting cells of interest, wherein the first normal vector is similar to a unit vector from among the plurality of cells;
defining a plurality of sub-regions with respect to the cells of interest; and
dividing a plane region based on a distance between adjacent cells of interest and a normal vector similarity, in each of the plurality of sub-regions.

11. The local map-based plane segmentation method of claim 10, further comprising:
calculating a steppability with respect to the plane region; and
determining the plane region as a steppable region when the calculated steppability is greater than or equal to a preset reference steppability.

12. The local map-based plane segmentation method of claim 10, wherein the calculating the first normal vector of each of the plurality of cells in the integrated point cloud-based local height map integrated in one coordinate system comprises:
calculating the first normal vector through averaging of cross products of direction vectors between a plurality of adjacent neighbor cells.

13. The local map-based plane segmentation method of claim 10, wherein the detecting the cells of interest of which the first normal vector and the defining the plurality of sub-regions with respect to the cells of interest comprises:
calculating a first cosine similarity between the unit vector comprising a z-axis unit vector and the first normal vector of each of the plurality of cells; and
detecting the cells of interest based on the calculated first cosine similarity.

14. The local map-based plane segmentation method of claim 13, wherein the detecting the cells of interest of which the first normal vector and the defining the plurality of sub-regions with respect to the cells of interest further comprises:
detecting a cell of which the first cosine similarity is greater than or equal to a predetermined reference similarity as the cell of interest.

15. The local map-based plane segmentation method of claim 10, wherein the detecting the cells of interest and the defining the plurality of sub-regions with respect to the cells of interest comprises:
defining the plurality of sub-regions each comprising preset N cells of interest.

16. The local map-based plane segmentation method of claim 11, wherein the dividing the plane region based on the distance between the adjacent cells of interest and the normal vector similarity, in each of the plurality of sub-regions comprises:
clustering the points of the cells of interest to generate a plurality of point clusters based on a distance between cell points of the cells of interest and a similarity of a second normal vector between the cells of interest.

17. The local map-based plane segmentation method of claim 16, wherein the calculating the steppability with respect to the plane region, and the determining the plane region as the steppable region when the calculated steppability is greater than or equal to the preset reference steppability comprises:
representing each of the plurality of point clusters as a polygon comprising vertices, a central point, and a third normal vector.

18. The local map-based plane segmentation method of claim 17, wherein the calculating the steppability with respect to the plane region, and the determining the plane region as the steppable region when the calculated steppability is greater than or equal to the preset reference steppability further comprises:
calculating the steppability based on a second cosine similarity between a z-axis unit vector and the third normal vector of the polygon.

19. A local map-based plane segmentation system, comprising:
a sensor unit comprising a plurality of cameras and an IMU sensor;
a data processor configured to:
compress data received from the sensor unit in the form of a local map;
define a plurality of sub-regions with respect to the compressed local map; and
detect a plane region based on the plurality of defined sub-regions; and
a robot unit configured to generate path planning based on a steppable region comprising the plane region.

20. The local map-based plane segmentation system of claim 19, wherein the data processor comprises:
a pose estimation module configured to estimate a pose of the robot with an input of RGBD data and IMU data;
an integrated point cloud generating module configured to generate an integrated point cloud integrated in one coordinate system by using the pose of the robot and camera parameter;
a local map generating module configured to compress the integrated point cloud, to generate a local height map; and
a plane segmentation module configured to define the plurality of sub-regions in the local height map, extract the steppable region in the plane region detected from the plurality of sub-regions, and transfer the extracted steppable region to the robot.
